(19) United States
(12) Patent Application Publication
(10) Pub. No.: US 2016/0376167 A1
(43) Pub. Date: Dec. 29, 2016

(54) SYSTEM AND METHOD FOR WASTEWATER VAPORIZATION

(71) Applicants: Milton F. Knight, Perrysburg, OH (US); Carlisle Knight, Perrysburg, OH (US)

(72) Inventors: Milton F. Knight, Perrysburg, OH (US); Carlisle Knight, Perrysburg, OH (US)

(21) Appl. No.: 14/985,911

(22) Filed: Dec. 31, 2015

Related U.S. Application Data
(60) Provisional application No. 62/098,685, filed on Dec. 31, 2014.

(51) Int. Cl. C02F 1/04; B01D 1/00; C02F 1/00

(52) U.S. Cl. CPC C02F 1/048; C02F 1/008; B01D 1/0005; B01D 1/0082; C02F 2209/005

(57) ABSTRACT

A method of operating a wastewater vaporization system includes providing wastewater to a flow head at a regulated rate, and operating the flow head to atomize the wastewater into droplets of a calculated size. The calculated size is based on measured environmental conditions.

### CROSS-REFERENCE TO RELATED APPLICATIONS

This application claims the benefit of U.S. Provisional Application No. 62/098,685, filed Dec. 31, 2014, the disclosure of which is incorporated herein by reference.

### BACKGROUND OF THE INVENTION

This invention relates in general to a system for reducing the volume of wastewater. More specifically, this invention relates to a system for accelerating the evaporation of portions of wastewater.

Many industrial and commercial activities produce wastewater as a byproduct. Wastewater contains contaminants including particulates that prevent it from being discharged into waterways for easy disposal. Wastewater is often transported to a treatment facility for purification prior to being discharged to a waterway, or for containment. Wastewater is also evaporated in order to reduce the volume of material that requires treatment or containment. It is desirable to have an improved system for evaporating wastewater.

### SUMMARY OF THE INVENTION

This invention relates to a method of operating a wastewater vaporization system. The method includes providing wastewater to a flow head at a regulated rate, and operating the flow head to atomize the wastewater into droplets of a calculated size. The calculated size is based on measured environmental conditions.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a component of a modular, deck-style, floatable vaporization system.

FIG. 2 is a side view of an assembled deck-style, floatable vaporization system in a water retention pond.

FIG. 3. is an overhead plan view of the system of FIG. 2.

FIG. 4 is an overhead plan view of a portion of the system of FIG. 3.

FIG. 5 is a perspective view of a portion of a gangway system connected to the vaporization system.

FIG. 6 is a perspective view of a component of a modular, lily pad style, floatable vaporization system.

FIG. 7 is a side view of a portion of an assembled lily pad style floatable vaporization system.

FIG. 8 is an overhead plan view of the portion of the system of FIG. 7.

FIG. 9 is an overhead plan view of a complete lily pad style floatable vaporization system.

FIG. 10 is an overhead plan view of an alternative lily pad style floatable vaporization system arrangement.

FIG. 11 is a perspective view of an alternative floatable vaporization system.

FIG. 12 is a side view of the alternative floatable vaporization system of FIG. 11.

FIG. 13 is a schematic diagram of a control system for a vaporization system.

### DETAILED DESCRIPTION OF THE PREFERRED EMBODIMENT

Referring now to the drawings, there is illustrated in FIG. 1 a perspective view of a component of a modular, deck-style, floatable vaporization system. The component includes a deck with attached floatation devices (not shown). The deck is adapted to float on the surface of a detention pond, as shown below. The illustrated deck includes two flow heads. The illustrated flow head are rotary atomizers such as, for example, a Proptec rotary atomizers made by Ledebuhr Industries. Each rotary atomizer is located on an outer end of a support arm that extends from a support column attached to the deck.

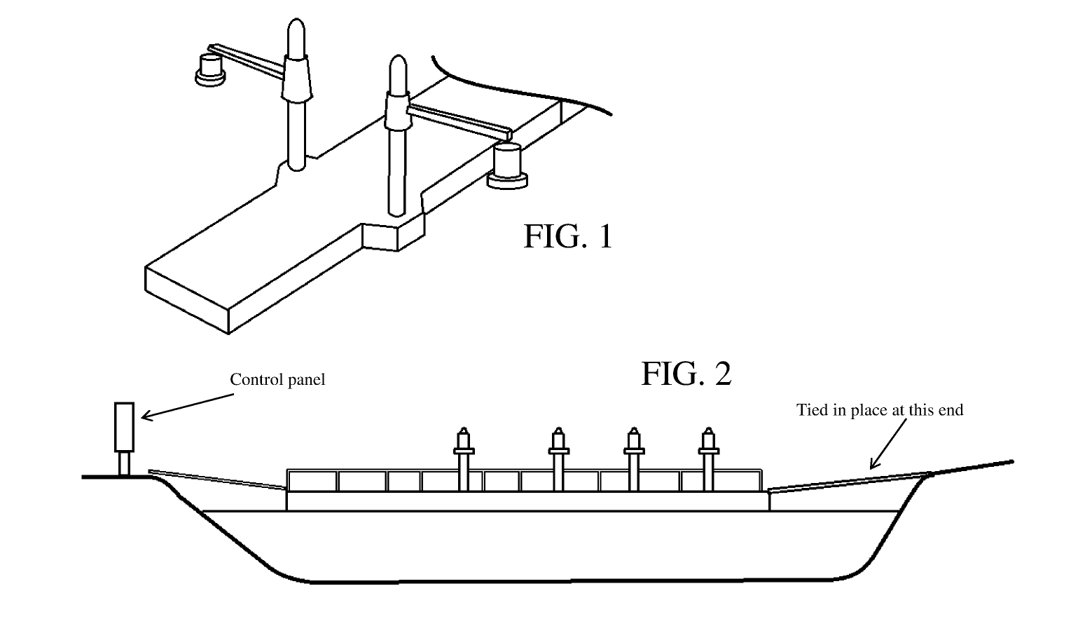

Referring to FIG. 2, a side view of an assembled deck-style, floatable vaporization system is shown floating on a water retention pond. The illustrated system is tethered to the ground surface to help maintain its position in the water retention pond. A gangway is provided to allow an operator to access the system from the ground surface. The system is adapted to remain floating on the surface of the retention pond when the operator is standing on the deck.

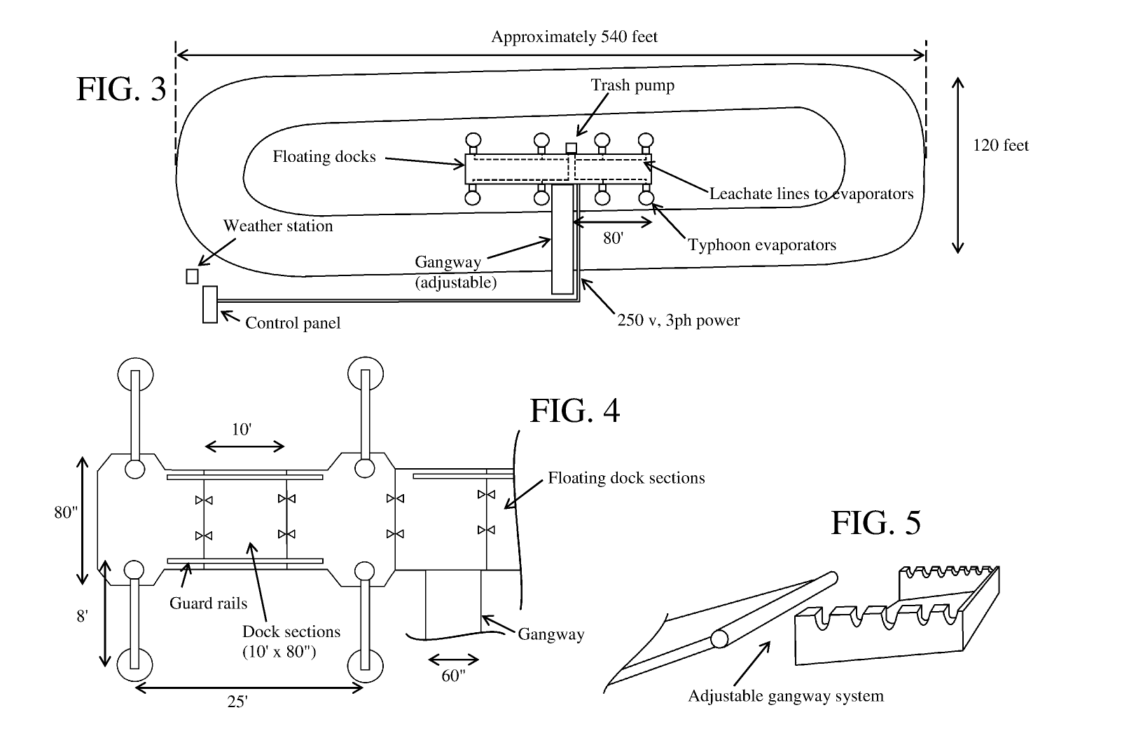

FIG. 3 is an overhead plan view of the system of FIG. 2, and FIG. 4 is a more detailed overhead view of a portion of the system of FIG. 2. The illustrated system is made of modular deck sections including flow head sections and connecting sections. The gangway is resting on a midsection of the system, and is connected to the ground surface by a gangway support shown in FIG. 5. The system includes a trash pump that is located below the surface of the retention pond, and is connected to pump water to the flow heads.

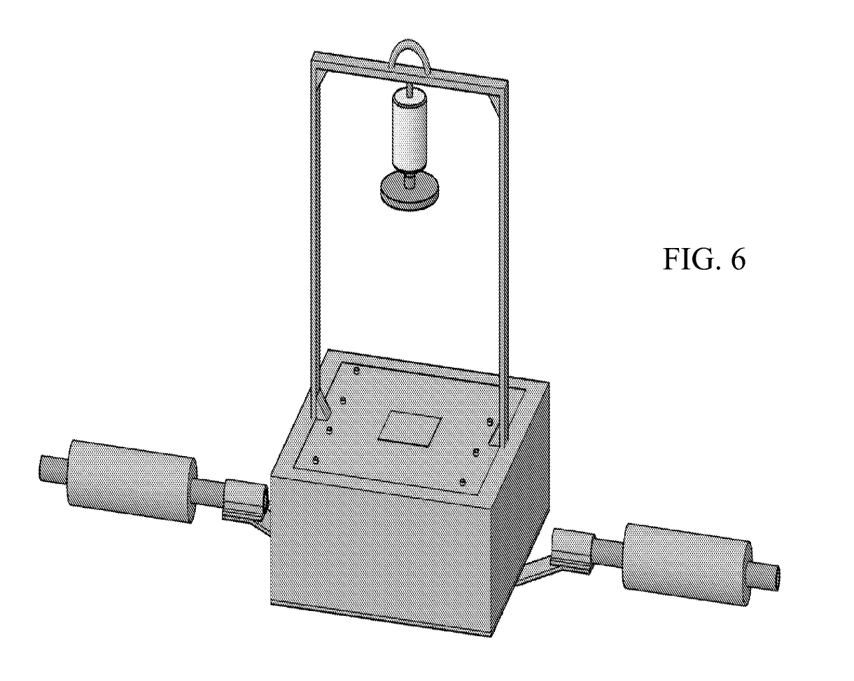

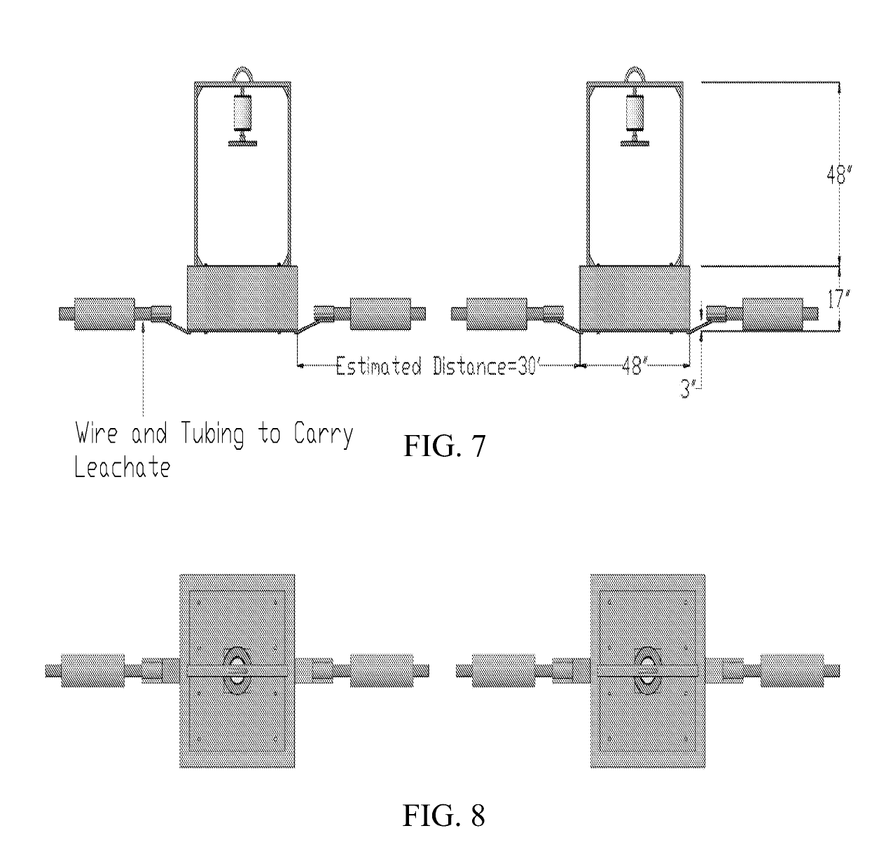

Referring to FIG. 6, a component of a modular, lily pad style, floatable vaporization system is shown. The component includes a floatable base that supports a flow head. The component includes connected tubing that allows wastewater to be pumped to the flow head and connected conduit that contains wiring that is connected to the flow head for control, as will be described below. FIG. 7 is a side view and FIG. 8 is an overhead view of two components connected in series.

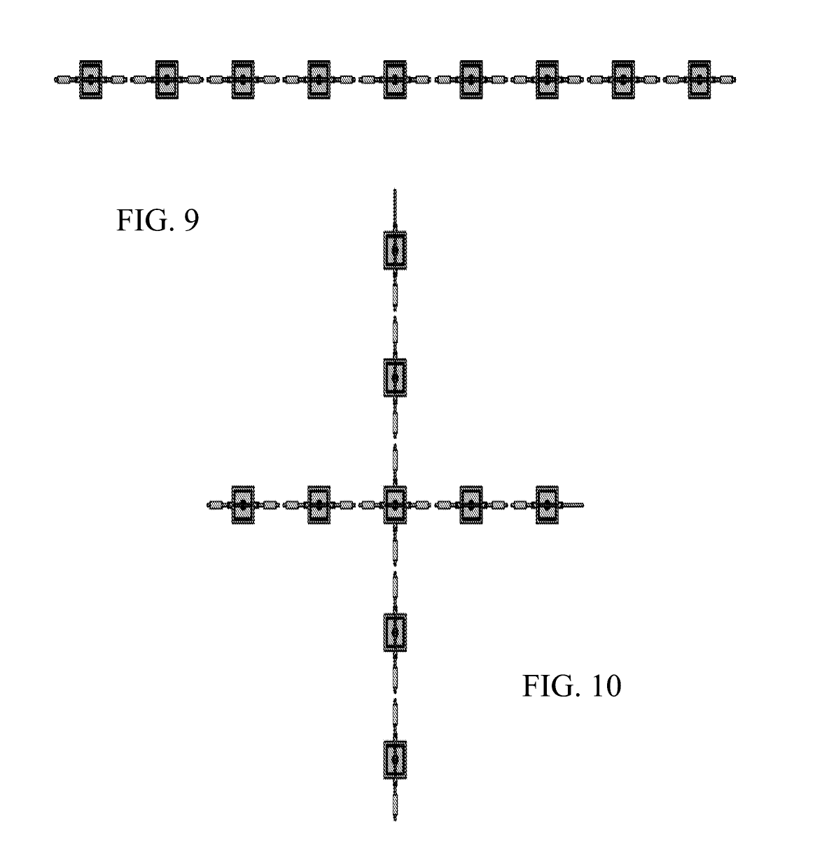

Referring to FIG. 9, an overhead view of a plurality of lily pad style components are connected in series is shown, and referring to FIG. 10, an alternative arrangement of a plurality of lily pad style components is shown. The lily pad components may be connected in any desired configuration, which may vary depending on the dimensions of the water retention pond.

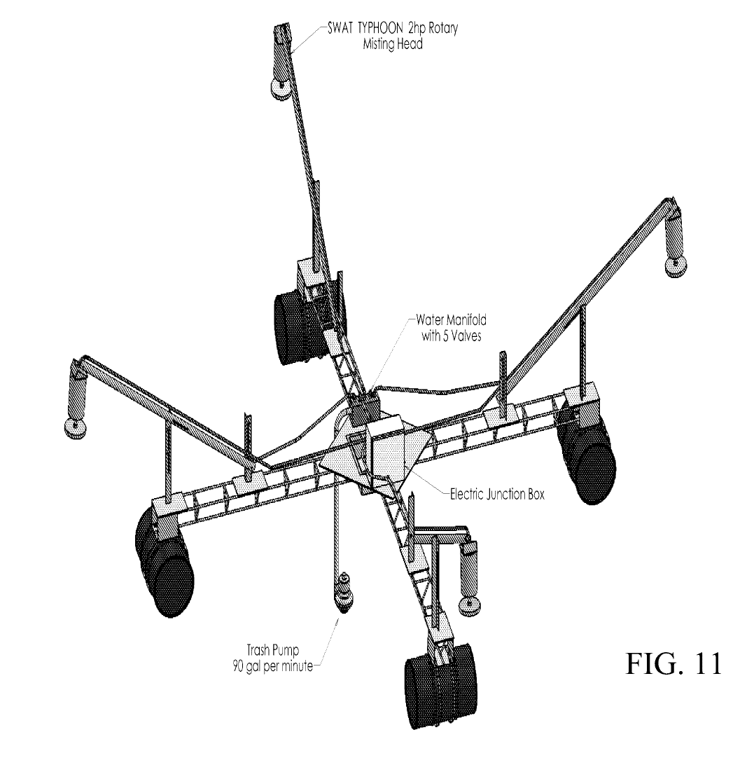

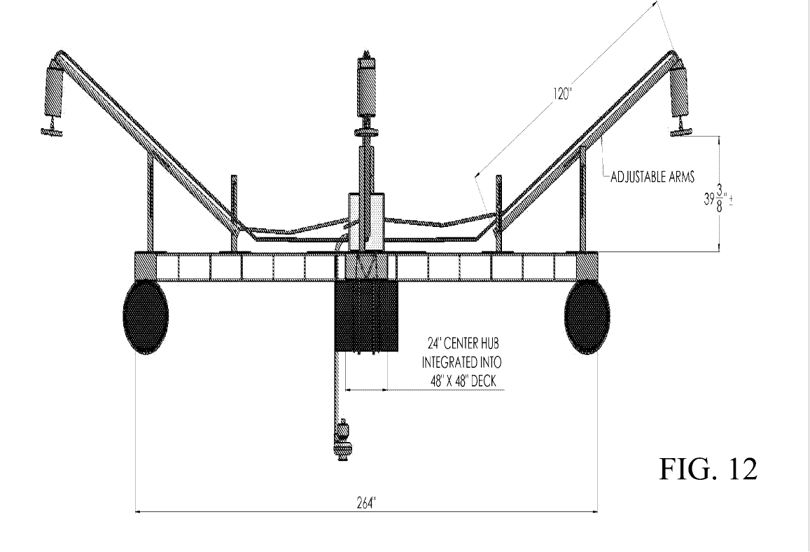

Referring to FIG. 11, a perspective view of a second alternative floatable vaporization system is shown, and FIG. 12 shows a side view of the second alternative floatable vaporization system. The second alternative floatable vaporization system includes a floatable base that supports a plurality of flow heads. A trash pump is adapted to be supported on the floatable base below the surface of the water retention pond, and is connected to provide water to a water manifold. The water manifold is connected to provide water flow to each of the flow heads.

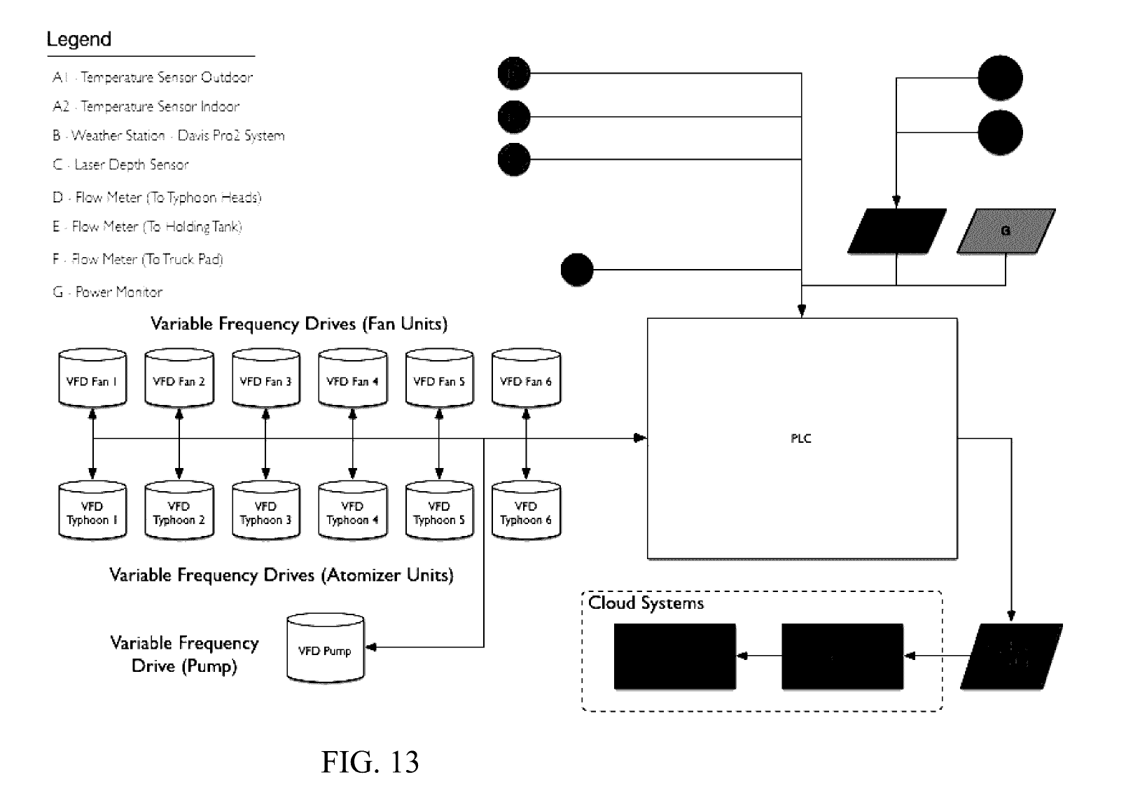

Referring to FIG. 13, a schematic view of a control system for a plurality of flow heads is shown. The control system is suitable for controlling any vaporization systems shown in FIGS. 1 through 12. Any of the vaporization systems shown in FIGS. 1 through 12 are suitable for use on a water retention pond that is located outdoors or indoors. Some of the components of the control system may not be used if the vaporization system is located indoors or outdoors. In the system illustrated in FIG. 13, one variable frequency pump provides water to six flow heads. Each of the flow heads is a fan assisted rotary atomizers.

The control system includes a sensors to detect and record inputs including: Temperature, wind speed, wind direction, solar radiation levels, relative humidity (outdoor), barometric pressure, rain volumes, in flow of leachate from landfill into pond, in flow of leachate to flow heads (totals), pump to flow heads RPMs, depth of pond/pond volume (outdoor systems), depth of open tank in cocoon (indoor system), voltage to each head (RPMs of each flow head), water temperature, sump pump outflow, fan speeds (indoor systems), interior humidity levels, and exterior humidity levels at exhaust of fans.

These inputs are provided to a programmable logic controller which calculates and records: Modeled evaporation rate per minute, refresh rate (indoor system), total evaporated to date, total evaporated for the day, total evaporated for the week, total evaporated for the month, total evaporated for life time of operation. The programmable logic controller is adapted to control the flow rate of the pump, the flow rate to each individual flow head, the rotational rate of each individual flow head, and the height of each individual flow head above the surface of the retention pond. This allows the programmable logic controller to control of the total volume of wastewater pumped through the vaporization system, as well as the size of water droplets expelled from each flow head. The programmable logic controller uses the inputs to calculate the evaporation potential of an environment around the vaporization system and adjusts the flows and RPMs of the flow heads to maximize the vaporization potential of the environment. Thus, the vaporization system output will match the maximum amount of water that can be evaporated by the system at a given time. If the vaporization system is indoors, the control system can include the control of airflow through the enclosed space by controlling ventilation fans or air supply fans, thus controlling the volume of air that can be saturated with vapor

Additionally, the control system may operate the vaporization system to control drift of the expelled wastewater. The drift is controlled by controlling the amount of wastewater that exits the flow head or controlling the RPMs of the flow head to control the droplet size. Smaller droplets will evaporate faster and larger droplets will drop faster and the control system can control droplet size in order to prevent the droplets from travelling outside a designated containment area. The programmable logic control will calculate a desired droplet size based on the inputs and operate the vaporization system to maintain the desired droplet size. Additionally, the desired droplet size may be different at different flow heads depending on the wind direction. Since the droplets from the flow head on the windward side of the vaporization system have a greater distance to travel before they are outside the designated containment area, those droplets may be a different size than the droplets from the flow head on the leeward side of the vaporization system.

The control system is designed to forecast evaporation potential of a specific space or environment and automatically adjust flows, rpms of equipment to maximize the vaporization potential of said space or environment. The control system accomplishes this task by doing 4 basic things: collecting data, analyze data using proprietary algorithms, notify operator the results of the data analysis and allow the end user to choose to manually adjust the system or allow the software to send control messages to the evaporation system to adjust flows, rpms to get the highest vaporization level calculated by said algorithms.

The control system uses a set of algorithms to control flow of liquid to an atomizer, adjust the rpms of rotary atomizing heads to create a balance between the volume of liquid being evaporated in the space and the speed at which the volume is refreshed. The control system also measures the wind direction and wind speed and when programmed with specific location parameters such as, distance from shore or max drift potential (how far you want the mist to travel when there is wind) allows the end user set safety parameters, which it uses to determine the ideal size of droplet that the particles need to be to prevent drift in the current weather conditions.

The control system is designed to calculate the maximum amount of water that can be evaporated by a system at a given time and then adjusting the system to match or meet that value. It also allows the ability to determine and report on the volume evaporated.

Sample variables used to determine adjustments:

Temperature (T)—Outdoor and Indoor Temperature are measured and feed to the PLC and used in calculations

Relative Humidity (RH)—Outdoor and Indoor Relative Humidity are measured and feed to the PLC and used in Calculations

Elevation—Elevation is stored for each site and is used in Calculations

Barometric Pressure—Is measured and used in Calculations

Wind Speed—Is measured for Outdoor Systems and are referenced in a table

Wind Direction—Is measured for Outdoor Systems and are referenced in a table

Flow Rate—The rate at which the liquid is going through the system or being added or subtracted from the system. Used in calculations

Air Volume—is measured and used in calculation the volume of air that passes through an indoor system or an outdoor system's virtual footprint. Indoor systems it is calculated in CFM.

These data points are used in a formula to determine the specific capacity of the air at any given time.

| | | | revised |
|---|---|---|---|
| Psat = | f(T) = | 6.112 * e\hat{ }[(17.67*T)/ | 6.1094 * e\hat{ }[(17.625*T)/ |
| | | (243.5 + T)] | (243.04 + T)] |
| Pavail = | | Psat*(1 − RH/100) | |
| Spec Cap = | | Pavail* 216.66/(T + | in grams per cubic meter |
| | | 273.15) | |

Fan Volume—The CFM value of each Fan or Fan Bank

Building Volume—Volume of air in building (Cubic Meters)

Fresh Air %—% of air entering exchange area that is NOT saturated air mixing back in

Evaporation %—% of water that actually evaporates during the exchange

Solids %—% of solids in the water (by volume)

Virtual Foot Print—is the imaginary footprint of a Typhoon head. This is determined in cubic feet and is based on the area that the mist falls in around the head itself. The choices are as follows
a) Dimensions—Length, Width, Height, Radius, Top Radius
b) Footprint Shape—Cone, Frustum Cone, Cylinder, Box

Indoor systems do a series of calculations different than those used by outdoor systems. The System for Indoors can include the control of airflow (on/off and Fan speed via PLC and a VFD) through the enclosed space thus controlling the volume in cubic feet or meters of air that can be saturated with vapor. The previous algorithm determined the maximum amount of liquid that can be added to a cubic meter of air. The control system for the indoor system can measure and control the volume of air that enters and leaves the cocoon building using cubic feet/meters per Minute. If using Feet it is converted to metric and then that number is factored into the algorithmic results and a maximum volume per minute is determined. The control system then displays the ideal flow rate for the evaporation heads which the end user can adjust to manually. When in automatic mode the control system may control the flow of the liquid to the heads either by controlling valves to each head or controlling the rpms of the pump feeding the evaporation heads. The RPMs is controlled by sending signals to a PLC that controls a VFD attached to the pumps. This flow rate is adjusted at intervals set by the end user.

The control system can record flow rates or volumes moved through the system and what is left over after the evaporation process by either recording the rpms of the pump or via an electronic flow meter. The control system records the amount of liquid pumped into the building and in a similar fashion measures the amount of liquid being held in a holding area which is comprised of the entire floor or it can measures the rpm of the recirculation pump or record the data feed of another electronic flow meter. The control system can then calculate the actual amount evaporated by date, hour, minute, year or lifetime of the system. This information is then uploaded to servers where it is stored in database tables that can be accessed via an online portal for reporting and ROI purposes.

Hardware that can be integrated into the control system include a wide variety of VFD's, Weather Stations, and Electronic meters.

In cases of extreme humidity when a high volume of mist is created the control system can adjust the RPM of the individual evaporation head thus controlling the size of the droplets. The faster the smaller the droplet the easier it is to carry. By slowing it down it creates larger droplet sizes. The control system calculates this and if the exterior relative humidity reaches a predetermined point the system begins to make larger drops.

This same process is used in outdoor systems where during the set up process the location is mapped out using GPS coordinates and safety parameters are set. These parameters are then used by the control system to determine the smallest size droplet that can be produced that will not drift past the boundaries previously set. The control system does this by adjusting the RPM's of the misting baskets.

The system calculates the optimal evaporation rate possible by adjusting several things to maintain the optimal evaporation rate possible:

RPM of Typhoon Unit—The RPM's of a basket can be slowed down or speed up by the system to increase or decrease the droplet size of the mist. This is used to control drift.

Flow Rate of Pump—The Flow of liquid to the Typhoon heads can be adjusted by adjusting the RPM/hz of the pump pushing the liquid to the Typhoon Units.

CFM of Fan Units—The Speed and volume of air that moves through a building is controlled by adjusting the RPM's of the Fan Motors by using a VFD and varying the signal

The outdoor system is primarily designed to control drift. The drift is controlled by, either limiting the amount of moisture that exits the basket or controlling the RPM's of the basket to control the droplet size. Unlike the Indoor System the Outdoor system will use two key data points to determine how the Automation adjusts the RPM and Flow Rate: Wind speed and wind direction.

The system may use a theoretical footprint. I currently use a 3×3 meter virtual box around each head that the wind will travel through. Think of it like an air duct and the windspeed is the flow rate of that duct. An example of the calculation is below.

Virtual Footprint=9 feet×9 feet×9 feet (3 cubic meter box)

Wind Speed=2 mph or 176 ft/sec

Refresh Rate=176/9=19.55× per minute

Combine this with the standard calculations we use for the indoor system and we can estimate the gallons that can be added per minute without oversaturating that airspace. This will also reduce the evaporation rate itself so particles that do drift as a liquid remain so for a very short period of time. This calculation would is optional if flow is incorporated into the system. This isn't necessary and the only automation mode may be is RPM based.

The outdoor system will adjust the RPM of the head based on Wind Conditions. The weather station will continuously monitor the wind direction, wind speed, wind gust speed, wind gust direction and 2 min average wind speed.

Each head may have a Table like the one below that would be used to determine the RPM of the System. Below is an example of just 1 but the table would be bigger if we had an entry for each sector.

| Wind Speed | RPM | Sector (1-12) |
|---|---|---|
| 0-3 | 4400 | 1, 2, 3, 4, 5, 6, 7, 8, 9, 10, 11, 12 |
| 3-5 | 3700 | 1, 2, 3, 4, 5, 6, 7, 8, 9, 10, 11, 12 |
| 5-7 | 2800 | 1, 2, 3, 4, 5, 6, 7, 8, 9, 10, 11, 12 |
| <7 | 1300 | 1, 2, 3, 4, 5, 6, 7, 8, 9, 10, 11, 12 |

Below is the logic the system will go through to determine the wind speed number when referencing the chart.

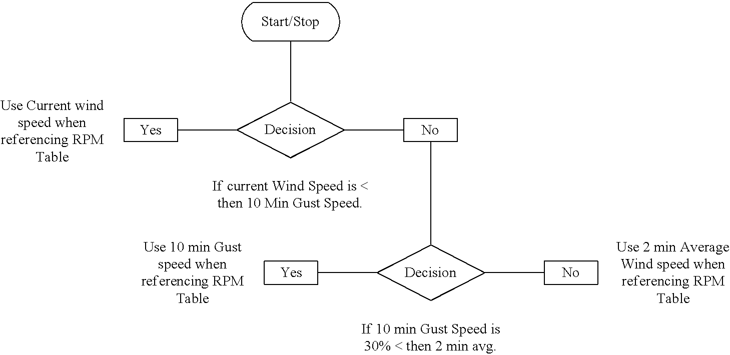

The idea is to be able to set up a unit at a location and be able to set limits based on environmental factors that will change. The primary focus is controlling the droplets from getting to areas where they will come into contact with People or Nature. Thus, keep the contaminants inside the designated containment area.

So if there are buildings to the South but clear to the north you would adjust the system table so that if the wind was blowing from the north you would adjust the RPM to prevent drift to where the people were. If it was blowing from the south the RPM's could remain high even though the wind speed is the same as it was when it came from the north and adjusted. Thus the determining factor is wind direction then wind speed.

The illustrated control system captures the wind speed every 2.5/5 or whatever interval you set the Weather Station too. If we had the system adjust to the wind direct every 2.5 seconds the system would never stop revving up and down. So I think we need to use an average. The Weather System currently tracks a 2 minute average on Wind Speed but nothing on Wind Direction. However we can program the PLC to average the last 2 minutes to give us a degree that is the average of the wind during that period.

In an alternative control method, the control system operates based on a calculated Water Evaporation Rate per Surface Area. Since we have a general guide on the size of the droplets produced at various RPM's and the benefits of using a basket makes them very uniform in size we can calculate a very close estimate on the surface area created at a given flow rate. Combine this with the Weather information collected from the station and the addition of a water temperature sensor we can calculate exactly how long it will take a droplet of that size to evaporate. Factor in wind speed and drift rate for a droplet at various sizes. We can then know exactly how far the droplet must travel to evaporate. The table below provides an example.

Then during the set up stage we would measure the distance from the flow head to the edge of the containment system and input those into a reference table that gives the unit the upper limit on max drift. The system would calculate evaporation rate and combine that with wind speed (Feet per Sec) and it could determine exactly the RPM' s necessary to keep the droplet size so the drift distance would never exceed its max. The Max would be set like the chart below. Set up would be simple you would measure the containment area to the head from 8 or 12 directions and enter them and be done:

| | North | | South | | South | | North |
|---|---|---|---|---|---|---|---|
| North | East | East | East | South | West | West | West |
| 50 | 56 | 200 | 220 | 180 | 78 | 88 | 160 |

Below is a Table of and example used at a set humidity and wind velocity used in crop dusting. However using this method you would have a huge amount of data and tables to reference but it gives you an idea of what would could do using this method.

TABLE 3
Effect of wind velocity and temperature on drift distances of
droplets directed downward with initial velocity of 65 ft/second toward
target 18 inches below discharge point. (Relative humidity = 50%;
Turbulence intensity = 20%)

| Initial | | | | | | | | | | | |
|---|---|---|---|---|---|---|---|---|---|---|---|
| Droplet | Wind | | | Drift Distance (ft) | | | | | | | |
| size | velocity | Head | Rel. | Temperature (degrees F.) | | | | | | | |
| (micron) | (mph) | RPM | Humidity | 35 | 45 | 55 | 65 | 75 | 85 | 95 | 105 |
| 20 | 2 | 6400 | 50% | | | 4.24* | 4.47 | 4.64 | 4.79* | | |
| 20 | 4 | 6400 | 50% | | | 7.23* | 7.33* | 7.71* | 7.79* | | |
| 20 | 6 | 6400 | 50% | | | 10.07* | 9.20* | 9.22* | 9.07 | | |
| 20 | 8 | 6400 | 50% | | | 12.82* | 11.33* | 10.42* | 10.38* | | |
| 20 | 10 | 6400 | 50% | | | 15.55* | 13.27* | 11.92* | 11.44 | | |
| 50 | 2 | 5800 | 50% | | | 15.73* | 14.97* | 13.51* | 12.60* | | |
| 50 | 4 | 5800 | 50% | | | 29.55* | 26.39* | 22.00* | 18.82* | | |
| 50 | 6 | 5800 | 50% | | | 43.28* | 37.87* | 30.19* | 25.18* | | |
| 50 | 8 | 5800 | 50% | | | 56.91* | 49.21* | 38.73* | 31.79* | | |
| 50 | 10 | 5800 | 50% | | | 70.92* | 60.31* | 46.97* | 37.90* | | |
| 100 | 2 | 4400 | 50% | | | 3.35 | 3.34 | 3.53 | 3.63 | | |
| 100 | 4 | 4400 | 50% | | | 6.69 | 6.71 | 7.03 | 7.23 | | |
| 100 | 6 | 4400 | 50% | | | 10.03 | 10.05 | 10.58 | 10.82 | | |
| 100 | 8 | 4400 | 50% | | | 13.37 | 13.40 | 14.08 | 14.44 | | |
| 100 | 10 | 4400 | 50% | | | 16.74 | 16.76 | 16.73 | 18.10 | | |
| 150 | 2 | 3900 | 50% | | | 0.94 | 0.92 | 0.96 | 0.94 | | |
| 150 | 4 | 3900 | 50% | | | 1.85 | 1.82 | 1.91 | 1.88 | | |
| 150 | 6 | 3900 | 50% | | | 2.77 | 2.73 | 2.85 | 2.81 | | |
| 150 | 8 | 3900 | 50% | | | 3.69 | 3.64 | 3.78 | 3.76 | | |
| 150 | 10 | 3900 | 50% | | | 4.64 | 4.56 | 4.75 | 4.70 | | |
| 200 | 2 | 3500 | 50% | | | 0.21 | 0.20 | 0.21 | 0.20 | | |
| 200 | 4 | 3500 | 50% | | | 0.39 | 0.39 | 0.39 | 0.38 | | |
| 200 | 6 | 3500 | 50% | | | 0.57 | 0.54 | 0.58 | 0.54 | | |
| 200 | 8 | 3500 | 50% | | | 0.74 | 0.76 | 0.78 | 0.74 | | |
| 200 | 10 | 3500 | 50% | | | 0.98 | 0.95 | 0.96 | 0.93 | | |

*Droplet completely evaporated before deposition.

The algorithm is designed to determine the optimal flow rate for any water based liquid and can come from any of the following: municipal solid waste, hazardous waste, and fracking oil and gas field production of liquid waste water known as flowback.

An aspect of the current invention provides entering basic parameters for an interior space which allows for finding the ideal sizing for the structure to based on the temperature, relative humidity, and elevation of the location using historical data

A further aspect of this invention is the calculated balancing of the following elements to achieve the maximum vaporization of liquid without the addition of gas, electric or geothermal thermal energy: the building volumetric size, building shape, volumetric flow rates of air stated as a factor of total building volume refresh rate, total volume of liquid being atomized per minute, the droplet size of the liquid being atomized (measured in microns)

Another aspect of this invention is the inclusion for integration the 2 stage atomization process so that the volume being misted can be infinitely adjusted from ¼ gallon per minute to as high as 8 gallons per minute which can increase or decrease the droplet size, thereby increasing or decreasing the mass of the droplet. Gallons per minute are also tied to the current relative humidity level.

Another aspect of this invention is the ability of the 2 stage atomization process to accept liquids which have up to 13% solids without the atomization process clogging the 2nd stage or 1st stage atomizer. This is important because often the liquid waste coming from a landfill setting or oil field production wastewater has high levels of suspended solids, which would or could clog a fixed, impingement or high-pressure nozzle.

Another aspect of the invention is to account for the heating of the air of the interior structure in increase the ability of the air to vaporize additional liquid in the algorithm. The interior structure can be heated using several different methods. The first method is through in introduction of heated air using current air handling equipment with large exhaust fans. The second method of heating the air is through the use of different building materials that absorb heat and dissipate the heat into the building structure, or using direct solar heat allowing sunlight to pass through the exterior structure. A third method of heating the air is through the use of indirect solar heat using solar water heat collectors. A fourth method of heating the air is through the use of heat exchangers using waste heat from the exhaust of diesel generators, heat from waste methane flares in the generation of electric power, and through gas heaters fired by excess gas from oil or gas field production.

Another aspect of this invention is the ability to take into account the calculation offset created by the ammonia content of a liquid being vaporized due to the oxygenation of the ammonia and it nitrification.

Another aspect of this invention is the ability to take into account the calculation offset created by the levels of salts in the liquids being vaporized

Another aspect of the invention is the construction of a long segment of the building or a space at the end of the building to allow for greater vaporization without particles contacting other particles, before the saturated air gets to be exhausted

Another aspect of the invention is to account for an open top holding storage tank and its impact on the evaporation volumes due to surface area exposure.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A method of operating a wastewater vaporization system, the method comprising:
providing wastewater to a flow head at a regulated rate; and
operating the flow head to atomize the wastewater into droplets of a calculated size, wherein the calculated size is based on measured environmental conditions.

2. The method of claim 1, wherein the measured environmental conditions include air temperature and relative humidity.

3. The method of claim 2, wherein the measured environmental conditions include wind speed and direction.

4. The method of claim 1, wherein the measured environmental conditions include wind speed and direction.

5. The method of claim 1, wherein the measured environmental conditions are an average value of on-going real-time measurements.

6. The method of claim 1, wherein the flow head is located within a designated containment area and the calculated size is determined to prevent the droplets from escaping the designated containment area based on the measured environmental conditions.

7. The method of claim 1, further comprising:
providing wastewater to a second flow head at a second regulated rate; and
operating the second flow head to atomize the wastewater into droplets of a second calculated size, wherein the second calculate size is based on measured environmental conditions.

8. A method of operating a wastewater vaporization system, the method comprising:
providing wastewater to a flow head at a flow rate that is based on measured environmental conditions; and
controlling a rotational rate of the flow head based on the measured environmental conditions.

9. The method of claim 8, wherein the measured environmental conditions include air temperature and relative humidity.

10. The method of claim 9, wherein the measured environmental conditions include wind speed and direction.

11. The method of claim 8, wherein the measured environmental conditions include wind speed and direction.

12. The method of claim 8, wherein the measured environmental conditions are an average value of on-going real-time measurements.

13. The method of claim 8, further comprising:
providing wastewater to a second flow head at a second flow rate that is based on measured environmental conditions; and
controlling a second rotational rate of the second flow head based on the measured environmental conditions.
